(19) United States
(12) Patent Application Publication
(10) Pub. No.: US 2009/0167562 A1
(43) Pub. Date: Jul. 2, 2009

(54) TRAFFIC LIGHT CONTROL SYSTEM FOR A HIGH FLOW INTERSECTION

(75) Inventor: Zhilong LIANG, Beijing (CN)

Correspondence Address: YING CHEN;Chen Yoshimura LLP, 255 S. GRAND AVE., # 215, LOS ANGELES, CA, 90012, US

(73) Assignee: AOCHENGTONGLI S&T DEVELOPMENT ( BEIJING ) CO., LTD, Beijing (CN)

(21) Appl. No.: 12/111,302

(22) Filed: Apr. 29, 2008

(30) Foreign Application Priority Data
Dec. 26, 2007 (CN) 200710303844.3

(51) Int. Cl. G08G 1/08

(52) U.S. Cl. 340/917

(57) ABSTRACT

The present invention relates to a traffic light control system for a high flow intersection comprising a CCU (Central Control Unit) and a plurality of surveillance cameras for monitoring the traffic condition in the intersection and on the lanes going out of the intersection, wherein the surveillance cameras capture traffic flow images in the intersection and on the outgoing lanes, which are converted by an interface circuit and sent to the CCU for processing, wherein the CCU determines whether an outgoing lane is in congestion according to the processed images, switches and keeps on red lights for corresponding directions when the outgoing lane is determined to be in congestion, and resumes the former lighting mode after the congestion is dissipated. Such a control system may, when an outgoing lane is determined to be in congestion, automatically switches and keeps on red lights of corresponding incoming lanes to prevent waiting vehicles from pulling in the intersection, thereby allowing the congestion to be dissipated.

### BACKGROUND OF THE INVENTION

1. Field of the Invention

This invention relates to a traffic light control system for a high flow intersection.

2. Description of Related Art

It is important for traffic lights to be controlled in a proper way. A commonly used traffic light control system is mounted in a traffic light control cabinet near the controlled lights by the road side. A CCU (Central Control Unit) is included to control the action of the traffic lights, such as switching sequence. The traffic light control system further has a mode setting device and a manual switching device. The mode setting device allows for manual parameter setting of traffic lights, including switching sequence and time intervals. The manual switching device allows for manual control, while one of the programmed modes will be implemented to control traffic flow on each direction if no manual control instructions are input. The shortcoming of the above solution is that when an outgoing lane is in congestion, other incoming vehicles pulling in the intersection may stop in the intersection and may cause a gridlock to the intersection, blocking the traffic flow of all other directions. Traffic administration has a regulation to prohibit any vehicle from pulling in under such a condition, even when the green light is on. But the regulation is hard to be implemented, because the driver cannot judge the condition ahead due to restricted perspective. When the flow is found to be slow, it is hard for him to decide whether he shall be able to drive out once he pulls in. It is of risk for him to choose either pulling in or pulling up. If his judgment is wrong, he may confront the fact that he is either blocking the intersection or wasting the traffic resources, that is, still creating a blocking for the following vehicles. Even worse, he may confront punishment.

### SUMMARY OF THE INVENTION

To overcome the shortcomings of the present art, the invention provides a traffic light control system for a high flow intersection. Such a control system may, when an outgoing lane is determined to be in congestion, automatically switch and keep on red lights of corresponding incoming lanes to prevent waiting vehicles from pulling in the intersection, thereby allowing the congestion to be dissipated.

The invention achieves the above objective by the solution of a traffic light control system for a high flow intersection comprising a CCU and a plurality of surveillance cameras for monitoring the traffic condition in the intersection and on the lanes going out of the intersection, wherein the surveillance cameras capture traffic flow images in the intersection and on the outgoing lanes, which are converted by an interface circuit and sent to the CCU for processing, wherein the CCU determines whether an outgoing lane is in congestion according to the processed images, switches and keeps on red lights for corresponding directions when the outgoing lane is determined to be in congestion, and resumes the former lighting mode after the congestion is dissipated.

The invention may automatically monitor and determine the traffic condition in the intersection and on the outgoing lanes, and may further, when an outgoing lane is determined to be in congestion, switch and keep on red lights of corresponding incoming lanes to prevent waiting vehicles from pulling in the intersection. An entire gridlock in the intersection derived from such invasions is therefore prevented and the driver's risk of making a wrong decision about whether to drive ahead is reduced. Such a traffic light control system is more effective in traffic guiding and more considerate for drivers. Drivers will not be punished simply because they are not able to judge the entire traffic condition.

### BRIEF DESCRIPTION OF THE DRAWINGS

FIG. 1 is a block diagram according to the embodiment of the invention.

### DESCRIPTION OF THE EMBODIMENTS

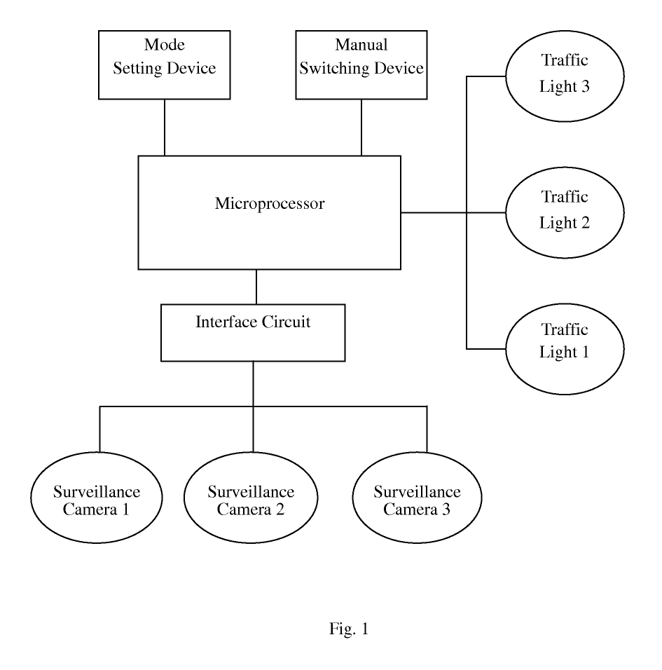

With reference to FIG. 1, the CCU may be a microprocessor for conducting vehicle identification by software and calculating the speed of observable vehicles by measuring the position variation and time interval between adjacent frames. The microprocessor determines, when a surveillance zone is crowded with vehicles driving slower than a particular speed or even in standstill, that there is congestion and switches on red lights for corresponding incoming directions.

The surveillance zone may be including the intersection and a certain distance away from the intersection exit (e.g. 5 to 20 m). The particular distance is chosen by computer simulation tests and field tests in accordance with traffic regulations as well as the specific field situation. The choice standard is maximum traffic flow and minimum gridlock. The particular speed as a threshold speed may be also chosen by the above tests and human experiences with reference to the capacity of the intersection and each outgoing lanes. As an example, the particular speed for defining congestion may be 5 km/h. When the actual speed is higher than 5 km/h, the time interval for light switching should usually be long enough for vehicles that have been pulling in the intersection to leave the intersection, or at least leave the next permitted lanes.

The surveillance cameras may be a single panoramic camera or a plurality of cameras for outgoing lanes, each camera capturing traffic flow images in the intersection and on the corresponding outgoing lane before a green light is on, and sending the traffic flow images to the microprocessor for processing. The microprocessor switches on a green light when the corresponding outgoing lane is determined to be not in congestion, or keeps the red light on when the corresponding outgoing lane is determined to be in congestion.

The said CCU has a mode setting device and a manual switching device. The mode setting device allows for manual parameter setting of traffic lights, including switching sequence and time intervals of traffic lights on each direction. And the manual switching device gives priority to manual switching when manual switching function is actuated.

The said CCU, the mode setting device, the manual switching device and the interface circuit for the communication between the cameras and the CCU are all mounted in a traffic light control cabinet. Buttons, keys or other actuators are configured on a panel exposed on the traffic light control cabinet, for manually controlling the mode setting device and the manual switching device. The traffic light control cabinet is equipped with an unauthorized-opening detection interface circuit and an alarm driver circuit, for receiving signals from an unauthorized-opening detector when the traffic light control cabinet door is opened or broken without authorization. The CCU, after receiving the unauthorized-opening signals, generates an alarm signal and sends the alarm signal to the alarm driver circuit to activate an alarm (e.g. an acoustic or visual alarm). In addition, the CCU also instructs any camera under its control to shoot the surroundings of the traffic light control cabinet to record what happens during and after the traffic light control cabinet door is opened or broken without authorization. The unauthorized-opening detector may be mounted on the door of the traffic light control cabinet. There may be one or two detectors so that the reliability is assured. When two or more traffic light control cabinets are used, there may be a same number of unauthorized-opening detection interface circuits for respective detectors. Any unauthorized-opening signal will trigger an individual alarm and shooting instruction.

The traffic light control cabinet is equipped with thermal insulation layers.

The traffic light control cabinet may have a front door, or a front and a rear door, and the thermal insulation layers may be attached on the side walls and the front door, or the front and the rear doors. The thermal insulation layers may also be attached on the other boards (e.g. the top board). The thermal insulation layers may be usually made of rock wool, which is heat insulating and fire proof.

The traffic light control cabinet may be equipped with a heating device, a cooling device and/or a ventilating device, for regulating the inner air condition so as to elongate the life of the contained electronic devices.

The ventilating device may be convective fans usually disposed at the top portion of the traffic light control cabinet. Such a configuration facilitates the air flow in the control cabinet. A plurality of air vents may be provided on the traffic light control cabinet, for better communication between internal and external air, thus providing appropriated temperature and humidity inside the cabinet.

The heating device may be electrical heater plates disposed at the lower portion of the inner surface of the two side walls of the traffic light control cabinet. Such a configuration may facilitate heat transfer within the traffic light control cabinet while occupies little space.

The electrical heater plates may be quartz heater plates that are compact and space saving. The heating device may warm the traffic light control cabinet in frigid winter days (e.g. of temperature≦−15 degrees C.), to assure the reliability of the control system. Such a function is particularly preferred in northern Chinese cities, especially those in the northeast and Inner Mongolia.

For saving space and simplifying installation, the cooling device may be a micro air-conditioning or an electrical cooling plate of other types. The electrical cooling plate may be disposed at the upper portion of the inner surface of the two side walls of the traffic light control cabinet, for better transfer of the cooling air. The electrical cooling plate may cool the traffic light control cabinet in summer days (e.g. of temperature≧45 degrees C.), to assure the reliability of the control system.

Each of the convection fans, the heating device and the cooling device may have an automatic control device, an electronic device inside the traffic light control cabinet. The convection fans, the heating device and the cooling device may be controlled by programming the corresponding automatic control device. A temperature sensor or a humidity sensor may be further equipped in the traffic light control cabinet as required. These sensors are connected to the corresponding automatic control devices of the convection fans, the heating device and the cooling device, so that the temperature and humidity data may be sent to the automatic control devices to conduct appropriate controls.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A traffic light control system for a high flow intersection, comprising a CCU for controlling traffic lights and a plurality of surveillance cameras for monitoring traffic conditions in the intersection and on lanes going out of the intersection, wherein the surveillance cameras capture traffic flow images in the intersection and on the outgoing lanes, which are converted by an interface circuit and sent to the CCU for processing, wherein the CCU processes the images and determines whether an outgoing lane is congested according to the processed images, switches and keeps on red lights for corresponding incoming directions when the outgoing lane is determined to be congested, and resumes a previous lighting mode after congestion is dissipated.

2. The traffic light control system for a high flow intersection according to claim 1, wherein the CCU is a microprocessor for conducting vehicle identification by software and calculating speeds of observable vehicles by measuring a position variation and a time interval between adjacent frames of images, wherein the microprocessor determines, when a surveillance zone is crowded with vehicles driving slower than a predetermined speed or in standstill, that there is congestion and switches on red lights for the corresponding incoming directions.

3. The traffic light control system for a high flow intersection according to claim 2, wherein the surveillance cameras are a single panoramic camera or a plurality of cameras for the outgoing lanes, each camera capturing traffic flow images in the intersection and on the corresponding outgoing lane before a green light is on, and sending the traffic flow images to the microprocessor for processing, wherein the microprocessor switches on a green light when the corresponding outgoing lane is determined to be not congested, or keeps the red light on when the corresponding outgoing lane is determined to be congested.

4. The traffic light control system for a high flow intersection according to claim 1, wherein the CCU has a mode setting device and a manual switching device, wherein the mode setting device allows for manual parameter setting of traffic lights, including switching sequence and time intervals of traffic lights on each direction, and wherein the manual switching device gives priority to manual switching when manual switching function is actuated.

5. The traffic light control system for a high flow intersection according to claim 4, wherein all the CCU, the mode setting device, the manual switching device and the interface circuit are mounted in a traffic light control cabinet.

6. The traffic light control system for a high flow intersection according to claim 5, wherein the traffic light control cabinet is equipped with an unauthorized-opening detection interface circuit and an alarm driver circuit, for receiving signals from an unauthorized-opening detector when the traffic light control cabinet door is opened or broken without authorization, wherein the CCU, after receiving the unauthorized-opening signals, generates an alarm signal and sends the alarm signal to the alarm driver circuit to activate an alarm.

7. The traffic light control system for a high flow intersection according to claim 6, wherein the CCU, after receiving the unauthorized-opening signals, further instructs the panoramic camera to shoot a surroundings of the traffic light control cabinet to record scenes during and after the traffic light control cabinet door is opened or broken without authorization.

8. The traffic light control system for a high flow intersection according to claim 7, wherein the traffic light control cabinet is equipped with thermal insulation layers, the thermal insulation layers being attached on side walls and a front door, or the front door and a rear door, of the traffic light control cabinet.

9. The traffic light control system for a high flow intersection according to claim 8, wherein the traffic light control cabinet is equipped with a heating device, a cooling device and/or a ventilating device, the ventilating device being convective fans, the heating device being electrical heater plates.

10. The traffic light control system for a high flow intersection according to claim 9, wherein the convective fans are disposed at a top portion of the traffic light control cabinet, wherein the electrical heater plates are disposed at a lower portion of an inner surface of the side walls of the traffic light control cabinet, the electrical heater plates being quartz heater plates, and wherein a plurality of air vents are provided on the traffic light control cabinet.

11. The traffic light control system for a high flow intersection according to claim 3, wherein the CCU has a mode setting device and a manual switching device, wherein the mode setting device allows for manual parameter setting of traffic lights, including switching sequence and time intervals of traffic lights on each direction, and wherein the manual switching device gives priority to manual switching when manual switching function is actuated.

12. The traffic light control system for a high flow intersection according to claim 11, wherein all the CCU, the mode setting device, the manual switching device and the interface circuit are mounted in a traffic light control cabinet.

13. The traffic light control system for a high flow intersection according to claim 12, wherein the traffic light control cabinet is equipped with an unauthorized-opening detection interface circuit and an alarm driver circuit, for receiving signals from an unauthorized-opening detector when the traffic light control cabinet door is opened or broken without authorization, wherein the CCU, after receiving the unauthorized-opening signals, generates an alarm signal and sends the alarm signal to the alarm driver circuit to activate an alarm.

14. The traffic light control system for a high flow intersection according to claim 13, wherein the CCU, after receiving the unauthorized-opening signals, further instructs the panoramic camera to shoot a surroundings of the traffic light control cabinet to record scenes during and after the traffic light control cabinet door is opened or broken without authorization.

15. The traffic light control system for a high flow intersection according to claim 14, wherein the traffic light control cabinet is equipped with thermal insulation layers, the thermal insulation layers being attached on side walls and a front door, or the front door and a rear door, of the traffic light control cabinet.

16. The traffic light control system for a high flow intersection according to claim 15, wherein the traffic light control cabinet is equipped with a heating device, a cooling device and/or a ventilating device, the ventilating device being convective fans, the heating device being electrical heater plates.

17. The traffic light control system for a high flow intersection according to claim 16, wherein the convective fans are disposed at a top portion of the traffic light control cabinet, wherein the electrical heater plates are disposed at a lower portion of an inner surface of the side walls of the traffic light control cabinet, the electrical heater plates being quartz heater plates, and wherein a plurality of air vents are provided on the traffic light control cabinet.
